(19) United States
(12) Patent Application Publication
(10) Pub. No.: US 2004/0120012 A1
(43) Pub. Date: Jun. 24, 2004

(54) Method for outputting a digital product definition of a printed product to a layout application

(76) Inventors: Laurens Leurs, Mortsel (BE); Koen Van de Poel, Berchem (BE)

Correspondence Address: Agfa Corporation, Law & Patent Department, 200 Ballardvale Street, Wilmington, MA, 01887-1069, US

(21) Appl. No.: 10/718,146

(22) Filed: Nov. 20, 2003

Related U.S. Application Data
(60) Provisional application No. 60/428,837, filed on Nov. 25, 2002.
(60) Provisional application No. 60/451,405, filed on Mar. 4, 2003.

(30) Foreign Application Priority Data
Nov. 21, 2002 (EP) EP 02102613.3
Feb. 14, 2003 (EP) EP 03100339.5

(51) Int. Cl. G06F 15/00; B41F 1/00

(52) U.S. Cl. 358/1.18; 358/1.1; 358/1.12

(57) ABSTRACT

A method for making a digital representation of a printed product, includes the steps of (a) creating by a planning application a product definition of the printed product and (b) outputting the product definition by the planning application to a layout application for using the product definition by the layout application for creating an artwork for making the digital representation of the printed product.

The application claims the benefit of U.S. Provisional Application No. 60/428,837 filed on Nov. 25, 2002 and of U.S. Provisional Application No. 60/451,405 filed on Mar. 4, 2003.

### FIELD OF THE INVENTION

The present invention relates to the generation of a digital representation of a product that is to be printed.

### BACKGROUND OF THE INVENTION

In the printing and publishing environment, different players interact in order to obtain print and publishing products, such as magazines, catalogues, promotional, corporate, book or specialty products in offset, flexo, screen, digital, sheet- or web-fed printing. Such products are called “printed products” in this document.

First, some terms are defined that are useful in the present patent application.

“Digital Representation of a Printed Product”: the product that is to be printed, represented in digital form.

“Artwork”: the electronic document that is generated by the “designer”, created while taking into account the “product definition”. The artwork is also called design, layout or publication. The artwork is thus a particular digital representation of the printed product.

“Designer”: the person in the creative department who will create an artwork in electronic format based on specific instructions and content.

“Product Definition”: the definition for the final printed product, holding manufacturing specifications. Some specifications that are important for a designer are: page size, bleed size, number of pages, set of colors used. A product definition often starts from a product intent.

“Layout application”: a software application that is used by the designer to generate the artwork. Common layout applications are InDesign™ from Adobe, Xpress™ from Quark, Illustrator™ from Adobe, FreeHand™ from Macromedia.

“Pre-press workflow application”: the pre-press department sets up a pre-press workflow for the printed product; the pre-press workflow application is the software application that is used to generate the pre-press product. Agfa Apogee™ is an example of a pre-press workflow application.

The designer needs to create the artwork according to the product definition. Later, the pre-press department will set up a workflow system, also according to the product definition. A problem is that, after the pre-press department receives the artwork from the creative department, and proceeds with it (e.g. Agfa Apogee™ may receive a PDF-file from Adobe InDesign™—wherein PDF stands for Portable Document Format), errors may be found. Such an error may be due to a mistake of the designer, who applied the instructions he received to create the artwork in a wrong way.

This problem is especially important since the creative department and the pre-press department are really “two different worlds” (“creative” people versus “production” people). Often, the creative and the pre-press departments belong to different companies.

There is still a need for an improved method for making a digital representation of a printed product.

### SUMMARY OF THE INVENTION

The present invention is a method for making a digital representation of a printed product, as claimed in independent claims 1 and 15. Preferred embodiments of the invention are set out in the dependent claims. Preferably, a method in accordance with the invention is implemented by a computer program product as claimed in independent claims 10 and 22. The invention also includes a data processing system that is suitable for carrying out a method in accordance with the invention, and a computer readable medium comprising program code adapted to carry out a method according to the invention when the program code is run on a computer.

Now, some additional terms are defined that are useful in the present patent application.

“Planning Application”, also called “Planning system”, “Project Management System” or “MIS” (acronym for Management Information System): a system that creates the product definition. In one embodiment of the invention, this product definition is used both by the creative department, that creates the artwork, and by the pre-press department, that sets up the pre-press workflow for the printed product. Generally, the product definition is also used by the finishing and the printing departments. An example of a planning application is the Agfa Delano™ software.

“Scripting”: a way to automate operations in an application. Scripting may be used to preset and/or lock some attributes in a layout application.

“Template”: a good example is a Word template. It is a special type of document that is set up with the proper information. When the designer starts to create the artwork, he may ask the layout application to create a new document based on a specific template.

For some applications, the template is limited to one (or two facing) page(s). In this case, the exact number of pages cannot be controlled.

A template, as defined in the present document, is not to be confused with an Imposition template.

“Starting document”: similar to a template but it is now already a ‘real’ document. The application can ‘Open’ it directly and start working into it.

“Template Generator”: a software application that creates a template to be used by a layout application, based on certain parameters (of the product definition).

“Locked” (template or artwork): one or more crucial attributes of a template or document may be locked so that the designer cannot modify them. Examples of such crucial attributes are page size, bleed size, number of pages, color model, spot colors. Remark: the terms “attributes” and “parameters”, e.g. of the product definition, are used as synonyms in the present document.

In a preferred embodiment of the invention, a planning application is used to create the product definition, and this product definition is used by the creative department, that creates the artwork. Preferably, this same product definition is also used by the pre-press department, that sets up the pre-press workflow for the printed product. This is advantageous since errors are avoided that may result from the transfer of the instructions from the planning system to the designer. Another advantage is that the pre-press department gets the instructions in the same way as the designer, which also avoids possible errors. It is preferred that a central planning system, that covers both the creative department and the pre-press department, is used to define the product before the creative work is started. In this way, no errors are introduced when transferring the product definition to another department.

In a particular embodiment of the invention, the basic document is then created automatically, based on this product definition. Further, it is preferred that at least one, and that more preferably all crucial attributes of the product definition are locked, so that they are protected from being modified by the layout application. Since the designer can thus no longer modify these attributes, possible errors by the designer are avoided.

Further advantages and embodiments of the present invention will become apparent from the following description and drawings.

### BRIEF DESCRIPTION OF THE DRAWINGS

The invention is described with reference to the following drawings without the intention to limit the invention thereto, and in which:

FIG. 1 illustrates an embodiment in accordance with the invention;

FIG. 2 illustrates another embodiment in accordance with the invention; and

FIG. 3 illustrates yet another embodiment in accordance with the invention.

### DETAILED DESCRIPTION OF THE PREFERRED EMBODIMENTS

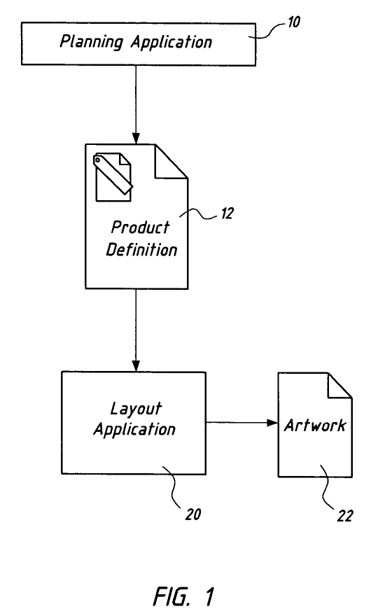

As discussed already above, in a preferred embodiment of the invention a planning application is used to create a product definition, and this product definition is used by the creative department. FIG. 1 shows such an embodiment. In FIG. 1, interpreted from the point of view of a planning department, the product definition 12 is output by a planning application 10 to a layout application 20; the layout application 20 uses the product definition 12 to create an artwork 22. From the point of view of the creative department, the product definition 12 is input by the layout application 20 from the planning application 10, and the layout application 20 uses the product definition 12 to create an artwork 22.

This same product definition 12 may be output by the planning application 10 to a pre-press workflow application (not shown in the drawings) and the pre-press workflow application may then use the product definition 12 to create a pre-press product. Two practical examples are as follows:

### Example 1

### Agfa Delano™ (as the planning application)

creates the product definition in JDF format (JDF stands for Job Definition Format);

sends the product definition to Adobe InDesign™ (as the layout application);

sends the product definition to Agfa Apogee™ (as the pre-press workflow application).

### Example 2

### Adobe InDesign™ (as the layout application)

creates a new document according to the product definition;

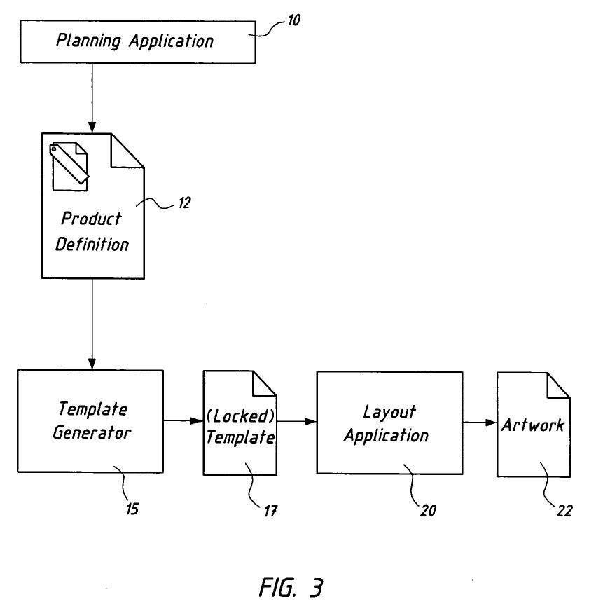

locks the attributes to avoid errors. Remark: in example 1, “sending” the product definition from Agfa Delano™ to Adobe InDesign™ means that Agfa Delano™, the planning application, outputs the product definition and that Adobe InDesign™, the layout application, inputs it. In this document, “inputting” and “outputting” may be either directly (from the first application to the second one) or indirectly (from the first to the second application via an intermediate application—this is illustrated e.g. by the embodiment illustrated by FIG. 3 and discussed below.

A method according to the invention may be implemented in many different ways, e.g. depending on what the layout application supports. As mentioned above, preferably a central planning system is used, that covers both the creative department and the pre-press department; such a planning system, or planning application 10, is indicated in FIGS. 1-3. However, a planning application 10 that creates the product definition 12 and that only sends it to the layout application 20, not to the pre-press workflow application, may also be used in the embodiments illustrated by FIGS. 1-3.

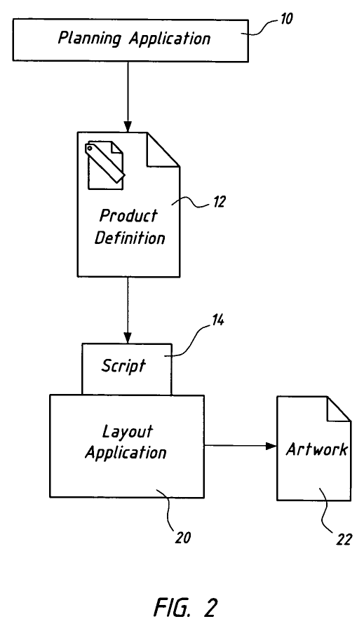

Of the embodiments illustrated by FIGS. 1-3, FIG. 1 shows the most integrated one, followed by FIG. 2, and FIG. 3 finally shows the least integrated embodiment.

In FIG. 1, the planning application 10 sends the product definition 12 (the product definition parameters) in a format that the layout application 20 understands.

FIG. 2 shows an embodiment wherein the planning application 10 sends the product definition 12 (the product definition parameters) to a script 14, also called intermediate script 14 in the present document; script 14 drives the layout application 20. The layout application 20 is driven by script 14 to produce the starting document (or template). Further below, an example of such a script is given for InDesign™, written in Visual Basic.

In the embodiment of FIG. 3, the product definition 12 (the product definition parameters) is sent by the planning application 10 to an intermediate application, a so-called template generator 15, that generates the document template 17 or starting document for the layout application 20. The intermediate application 15 translates the product definition 12 to a particular format, i.e. template 17, that the layout application understands. One or more attributes of the template 17 may be locked so that the designer cannot modify them.

The following example is a script, written in Visual Basic, for InDesign™; it illustrates the embodiment of FIG. 2.

### EXAMPLE

```
‘ version 0.99
‘ by Koen Van de Poel
‘ Copyright Agfa-Gevaert N.V.
‘ 2002-12-07
‘
‘ Sample script for Indesign that allows to Import a JDF with
Product Intents
‘ set-up a UI with it and then create an Indesign or Illustrator
Document with the required settings
‘
‘ Option Explicit
Dim xmldoc As DOMDocument
‘ Creates the Indesign document
Private Sub Indesign_Click( )
  Dim myInDesign As Indesign.Application
  Dim myDocument As Indesign.Document
  Dim myTextFrame As Indesign.TextFrame
  Set myInDesign = CreateObject(“Indesign.Application.2.0”)
  Rem maak nieuwe pub
  Set myDocument = myInDesign.Documents.Add
  Rem copy from interface
  myDocument.DocumentPreferences.NumberOfPages =
CInt(NrPages.Text)
  myDocument.DocumentPreferences.PageWidth =
  PageWidth.Text & “mm”
  myDocument.DocumentPreferences.PageHeight = PageHeight.Text &
“mm”
  ‘ myDocument.Name = Title.Text
  Set myMetaDataPreferences = myDocument.MetaDataPreferences
  myMetaDataPreferences.Author = “KVDP Indesign JDF Script”
  myMetaDataPreferences.JobName = JobName.Text
  myMetaDataPreferences.Description = Description.Text
  myMetaDataPreferences.Title = Title.Text
Rem just to show something
  Set myTextFrame = myDocument.Spreads.Item(1).TextFrames.Add
  myTextFrame.GeometricBounds = Array(“10 mm”, “10 mm”,
“30 mm”, “30 mm”)
  myTextFrame.TextContents = “Hello World”
End Sub
‘ Similar stuff for Illustrator automation
Private Sub IllustratorButton_Click( )
  Dim appRef As New Illustrator.Application
  Dim newDoc As Illustrator.Document
  Dim newCMYKColor As New Illustrator.CMYKColor
  Dim newColor As New Illustrator.Color
  Dim newSpot As Illustrator.Spot
  Dim frontPath As Illustrator.PathItem
    Rem copy from interface
  ‘myDocument.DocumentPreferences.NumberOfPages =
CInt (NrPages.Text)
  ‘myDocument.DocumentPreferences.PageWidth = PageWidth.Text &
“mm”
  ‘myDocument.DocumentPreferences.PageHeight = PageHeight.Text &
“mm”
  ‘ myDocument.Name = Title.Text
  ‘Set myMetaDataPreferences = myDocument.MetaDataPreferences
  ‘myMetaDataPreferences.Author = “KVDP Indesign JDF Script”
  ‘myMetaDataPreferences.JobName = JobName.Text
  ‘myMetaDataPreferences.Description = Description.Text
  ‘myMetaDataPreferences.Title = Title.Text
  ‘AppActivate “Adobe Illustrator”
  ‘Set appRef = CreateObject (“Illustrator.Application.10.0”)
  ‘ Create the document
  Set newDoc = appRef.Documents.Add(aiDocumentCMYKColor,
(CInt(PageWidth.Text) * 72) / 25.4, (CInt(PageHeight.Text) * 72) /
25.4)
  ‘ Create a spot color (as test)
  newCMYKColor.cyan = 22
  newCMYKColor.yellow = 100
  newCMYKColor.black = 33
  newCMYKColor.magenta = 44
  newColor.CMYK = newCMYKColor
  Set frontDocument = appRef.ActiveDocument
  Set newSpot = frontDocument.Spots.Add
  newSpot.Color = newColor
  newSpot.ColorType = aiSpot
  newSpot.name = “Koens Spot”
End Sub
Rem Import JDF
Private Sub initxmldoc( )
  Set xmldoc = Nothing
  Set xmldoc = CreateObject(“Msxml.DomDocument”)
  xmldoc.async = False
End Sub
‘ Load the JDF document into internal structure
Private Function LoadJDF(xmldoc As DOMDocument, filepath As String)
As Boolean
  Dim runlistnode As IXMLDOMNode
  Dim bLoadOK As Boolean
  Dim Title As String
  bLoadOK = False
  If Not (IsNull(xmldoc)) Then
    xmldoc.Load filepath ‘ load XML file as document
    ‘ quick validity check by looking for Runlist
    If IsValidNode(xmldoc.documentElement) Then
      Set runlistnode =
xmldoc.documentElement.selectSingleNode(kSizeIntentDimensions)
      If Not IsValidNode(runlistnode) Then
        Dim mResult As VbMsgBoxResult
        ‘ allow to proceed, should be better with Proceed
stop buttons !!
        mResult = MsgBox(“This JDF file is not supported (no
SizeIntent found).” & Chr(10) & “Use supplied templates.” & Chr(10)
& filepath & Chr(10) & _{—}
        “Click ‘Yes’ to Proceed anyway and ‘No’ to stop.”, _{—}
        vbYesNo + vbDefaultButton2 + vbCritical)
        If (mResult = vbNo) Then
          bLoadDefault = False
        End If
      Else: bLoadOK = True
      End If
      If bLoadOK Then
        ‘ check if file has proper version
        Dim vers As String
        ‘vers = GetJDFVersion(xmldoc)
        ‘If Not ((vers = JDFVersion10) Or (vers =
JDFVersion11)) Then
        ‘ MsgBox “The version of this JDF file (version:“
& vers & ”) is not supported.” & Chr(10) & “Use supplied templates.”
& filepath, vbOKOnly + vbCritical
        ‘ bLoadDefault = True
        ‘ End If
      End If
    Else ‘ invalid document element
      MsgBox “Could not open JDF ” & filepath, vbOKOnly +
vbCritical
      bLoadOK = False
    End If
  End If
  LoadJDF = bLoadOK
End Function
Private Sub Command1_Click( )
End Sub
Rem Import JDF
‘ This function allows the user to select a JDF file (triggered by
clicking the ImportJDF button in the UI)
Private Sub ImportJDF_Click( )
  Dim FileName As String
  ‘ InitXML
  Set xmldoc = Nothing
  Set xmldoc = CreateObject(“Msxml.DomDocument”)
  xmldoc.async = False
  Dim filepath As Variant
  Dim strFilter As String
  Dim IngFlags As Long
  ‘ Prepare Select File dialog box
  strFilter = ahtAddFilterItem(strFilter, “JDF Files (*.jdf)”,
“*.jdf”)
  strFilter = ahtAddFilterItem(strFilter, “All Files (*.*)”,
“*.*”)
  filepath = ahtCommonFileOpenSave(InitialDir:=“”, _{—}
    Filter:=strFilter, FilterIndex:=1, flags:=lngFlags, _{—}
    DialogTitle:=“Open”, hwnd:=Me.hwnd)
  ‘ Extract the data needed from the JDF file
  If (filepath <> vbNullString) Then
    FileName = filepath
    ‘ Load the file
    If LoadJDF(xmldoc, FileName) Then
      ‘ Extract the data and copy to locals
      Description.Text = GetJDFDescriptiveName(xmldoc)
      JobName.Text = GetJDFJobID(xmldoc)
      NrPages.Text = GetJDFIntentPages(xmldoc)
      JDFDimensions = GetJDFIntentDimensions(xmldoc)
      ‘ Convert to mms
      sPos = InStr(JDFDimensions, “ ”)
      Wstr = Left(JDFDimensions, sPos − 1)
      Hstr = Mid(JDFDimensions, sPos + 1)
      W = Round((CDbl(Wstr) / 72) * 25.4)
      PageWidth.Text = W
      H = Round((CDbl(Hstr) / 72) * 25.4)
      PageHeight.Text = H
    End If
  End If
End Sub
```

Those skilled in the art will appreciate that numerous modifications and variations may be made to the embodiments disclosed above without departing from the scope of the present invention.

### LIST OF REFERENCE SIGNS

10: planning application

12: product definition

14: script

15: template generator

17: template

20: layout application

22: artwork

1. A method for making a digital representation of a printed product comprising:
creating by a planning application a product definition of said printed product; and
outputting said product definition by said planning application to a layout application for using said product definition by said layout application for creating an artwork for making said digital representation of said printed product.

2. The method according to claim 1 further comprising outputting said product definition by said planning application to a pre-press workflow application for using said product definition by said pre-press workflow application for creating a pre-press product.

3. The method according to claim 1 wherein said product definition comprises a first parameter selected from the group of a page size, a number of pages, a bleed size and a set of colors used.

4. The method according to claim 1 further comprising locking a second parameter of said product definition for protecting said second parameter from being modified by said layout application.

5. The method according to claim 2 further comprising locking a second parameter of said product definition for protecting said second parameter from being modified by said layout application.

6. The method according to claim 1 further comprising creating said product definition in Job Definition Format, i.e. JDF.

7. The method according to claim 1 further comprising outputting said product definition by said planning application to an intermediate script for driving said layout application.

8. The method according to claim 1 further comprising outputting said product definition by said planning application to an intermediate application for sending said product definition in a particular format to said layout application.

9. A data processing system for making a digital representation of a printed product comprising:
means for creating by a planning application a product definition of said printed product; and
means for outputting said product definition by said planning application to a layout application for using said product definition by said layout application for creating an artwork for making said digital representation of said printed product.

10. The data processing system of claim 9, further comprising means for outputting said product definition by said planning application to a pre-press workflow application for using said product definition by said pre-press workflow application for creating a pre-press product.

11. The data processing system of claim 9, wherein said product definition comprises a first parameter selected from the group of a page size, a number of pages, a bleed size and a set of colors used.

12. The data processing system of claim 9 further comprising means for locking a second parameter of said product definition for protecting said second parameter from being modified by said layout application.

13. The data processing system of claim 10 further comprising means for locking a second parameter of said product definition for protecting said second parameter from being modified by said layout application.

14. The data processing system of claim 9 further comprising means for creating said product definition in Job Definition Format, i.e. JDF.

15. The data processing system of claim 9 further comprising means for outputting said product definition by said planning application to an intermediate script for driving said layout application.

16. The data processing system of claim 9 further comprising means for outputting said product definition by said planning application to an intermediate application for sending said product definition in a particular format to said layout application.

17. A computer program product for making a digital representation of a printed product, the computer program product comprising:
first program instructions for creating by a planning application a product definition of said printed product; and
second program instructions for outputting said product definition by said planning application to a layout application for using said product definition by said layout application for creating an artwork for making said digital representation of said printed product.

18. The computer program product according to claim 17 further comprising a computer readable medium wherein said first and second program instructions are recorded on said medium.

19. The computer program product according to claim 17 further comprising third program instructions for locking a parameter of said product definition for protecting said parameter from being modified by said layout application.

20. The computer program product according to claim 17 further comprising fourth program instructions for outputting said product definition by said planning application to an intermediate script for driving said layout application.

21. The computer program product according to claim 17 further comprising fifth program instructions for outputting said product definition by said planning application to an intermediate application for sending said product definition in a particular format to said layout application.

22. A method for creating an artwork for making a digital representation of a printed product, the method comprising:
inputting a product definition of said printed product by a layout application from a planning application; and
using said product definition for creating said artwork by said layout application.

23. The method according to claim 22 wherein said product definition comprises a first parameter selected from the group of a page size, a number of pages, a bleed size and a set of colors used.

24. The method according to claim 22 further comprising locking a second parameter of said product definition for protecting said second parameter from being modified by said layout application.

25. The method according to claim 22 further comprising creating said product definition in Job Definition Format, i.e. JDF.

26. The method according to claim 22 further comprising outputting said product definition by said planning application to an intermediate script for driving said layout application.

27. The method according to claim 22 further comprising outputting said product definition by said planning application to an intermediate application for sending said product definition in a particular format to said layout application.

28. A data processing system for creating an artwork for making a digital representation of a printed product, the system comprising:
means for inputting a product definition of said printed product by a layout application from a planning application; and
means for using said product definition for creating said artwork by said layout application.

29. The data processing system of claim 28 wherein said product definition comprises a first parameter selected from the group of a page size, a number of pages, a bleed size and a set of colors used.

30. The data processing system of claim 28 further comprising means for locking a second parameter of said product definition for protecting said second parameter from being modified by said layout application.

31. The data processing system of claim 28 further comprising means for creating said product definition in Job Definition Format, i.e. JDF.

32. The data processing system of claim 28 further comprising means for outputting said product definition by said planning application to an intermediate script for driving said layout application.

33. The data processing system of claim 28 further comprising means for outputting said product definition by said planning application to an intermediate application for sending said product definition in a particular format to said layout application.

34. A computer program product for creating an artwork for making a digital representation of a printed product, the computer program product comprising:
first program instructions for inputting a product definition of said printed product by a layout application from a planning application; and
second program instructions for using said product definition for creating said artwork by said layout application.

35. The computer program product according to claim 34 further comprising a computer readable medium wherein said first and second program instructions are recorded on said medium.

36. The computer program product according to claim 34 further comprising third program instructions for locking a parameter of said product definition for protecting said parameter from being modified by said layout application.

37. The computer program product according to claim 34 further comprising fourth program instructions for outputting said product definition by said planning application to an intermediate script for driving said layout application.

38. The computer program product according to claim 34 further comprising fifth program instructions for outputting said product definition by said planning application to an intermediate application for sending said product definition in a particular format to said layout application.
